(19) United States
(12) Patent Application Publication
(10) Pub. No.: US 2026/0141596 A1
(43) Pub. Date: May 21, 2026

(54) MAP GENERATION METHOD, COMPUTER APPARATUS AND STORAGE MEDIUM

(71) Applicant: Douyin Vision Co., Ltd., Beijing (CN)

(72) Inventor: Gaole HUANG, Beijing (CN)

(21) Appl. No.: 19/119,698

(22) PCT Filed: Feb. 2, 2024
(86) PCT No.: PCT/CN2024/075515

§ 371 Date: Apr. 9, 2025

(30) Foreign Application Priority Data
Feb. 10, 2023 (CN) 202310149671.3

(51) Int. Cl. G06T 11/60; A63F 13/5378; A63F 13/69; G06T 5/70

(52) U.S. Cl. CPC G06T 11/60; A63F 13/5378; A63F 13/69; G06T 5/70

(57) ABSTRACT

A map generation method, a computer apparatus and a storage medium are provided. The map generation method includes: obtaining a map path transition probability of each pixel point within a preset geographic range; generating an initial map path based on the transition probability; for each pixel point, determining whether the pixel point belongs to an intermediate map path, based on a proportion of pixel points belonging to the initial map path among neighborhood pixel points, to obtain the intermediate map path; and using the intermediate map path as an initial map path after updating, repeatedly performing a step of determining the intermediate map path until a preset number of iterations is reached, and generating a target map based on an intermediate map path after a last iteration.

This application claims priority to Chinese Patent Application No. 2023101496713 filed on Feb. 10, 2023, the disclosure of which is incorporated herein by reference in its entirety as a part of this application.

### TECHNICAL FIELD

Embodiments of the present disclosure relate to a map generation method and device, a computer apparatus, and a storage medium.

### BACKGROUND

Currently, a corresponding game map is usually designed for a game scene, and players are provided with more diversified gameplay based on the game map. In the related art, the game map is mainly drawn manually, which is time-consuming and laborious if the game map is large and the scene is complex. Moreover, in order to improve the accuracy of the drawn game map, the staff who draw the game map are usually required to have certain professional knowledge, which further increases the labor cost of drawing the game map.

### SUMMARY

Embodiments of the present disclosure provide at least a map generation method and device, a computer apparatus, and a storage medium.

In a first aspect, an embodiment of the present disclosure provides a map generation method. The method includes: obtaining a map path transition probability of each pixel point within a preset geographic range, wherein the map path transition probability is used to indicate a probability of the pixel point changing from a non-map path pixel point to a map path pixel point: generating an initial map path based on the map path transition probability: determining, for the pixel point in the preset geographic range, whether the pixel point belongs to a pixel point in an intermediate map path based on a proportion of pixel points belonging to the initial map path among neighborhood pixel points of the pixel point, to obtain the intermediate map path; and using the intermediate map path as an updated initial map path, repeatedly performing the step of determining the intermediate map path until a preset number of iterations is reached, and generating a target map based on an intermediate map path obtained after a last iteration.

In an optional implementation, the generating the target map based on the intermediate map path obtained in the last iteration comprises: when a plurality of map path portions are not connected in the intermediate map path, starting a plurality of agent threads; determining a current to-be-connected map path portion from the plurality of map path portions, randomly selecting one pixel point from the current to-be-connected map path portion as a start pixel point for each of the plurality of agent threads, and randomly generating one candidate path from the start pixel point to another map path portion; and using a shortest path in the candidate paths generated by the plurality of agent threads as a path of the target map; and repeating a step of determining the current to-be-connected map path portion from the plurality of map path portions until connection for the plurality of map path portions are established, to obtain the path of the target map.

In an optional implementation, before the generating the initial map path based on the map path transition probability, the method further comprises: obtaining a path sketch drawn by a user; generating a skeleton map based on the path sketch, wherein a style of the skeleton map matches a style of the path sketch, and the skeleton map comprises no pixel point belonging to the path sketch; and determining the map path transition probability based on the path sketch and the skeleton map.

In an optional implementation, the determining the map path transition probability based on the path sketch and the skeleton map comprises: determining a map path transition probability of each pixel point outside the path sketch and the skeleton map belonging to the initial map path, based on an obtained path width weight and a Manhattan distance from the pixel point outside the path sketch and the skeleton map in the preset geographic range to the path sketch, setting a map path transition probability of the pixel point in the path sketch to be 1, and setting a map path transition probability of the pixel point in the skeleton map to be 0.

In an optional implementation, the determining a map path transition probability of each pixel point outside the path sketch and the skeleton map belonging to the initial map path comprises: based on a plurality of path width weights which are obtained and the Manhattan distance from the pixel point to the path sketch, determining a map path transition probability of the pixel point under each of the plurality of path width weights, respectively; the generating an initial map path based on the map path transition probability comprises: generating a plurality of initial map paths based on the map path transition probabilities respectively corresponding to the plurality of path width weights, and after obtaining a plurality of paths of target maps respectively corresponding to the plurality of initial map paths, the method further comprises: displaying the plurality of paths of target maps, and determining a path of target map selected by the user from the plurality of paths of target maps.

In an optional implementation, after the generating the target map, the method further comprises: in response to receiving modification information for the path sketch from the user, updating the target map based on a path portion which is indicated to be modified by the modification information.

In an optional implementation, the updating the target map based on the path portion which is indicated to be modified by the modification information comprises: determining an updated path sketch based on the path portion which is indicated to be modified by the modification information, and generating an updated skeleton map based on the updated path sketch; and determining an associated geographic range corresponding to the path portion which is indicated to be modified: updating the map path transition probability based on the updated path sketch, the updated skeleton map, and the associated geographic range, wherein setting a map path transition probability of each pixel point located in the path of the target map before the updating and outside the associated geographic range to be 1, and setting a map path transition probability of each pixel point not located in the path of the target map before the updating to be 0; and generating an initial map path after updating based on the map path transition probability after updating, and generating a target map after updating based on the initial map path after updating.

In an optional implementation, the updating the map path transition probability based on the updated path sketch, the updated skeleton map, and the associated geographic range comprises: determining an updated map path transition probability corresponding to each target pixel point, based on the path width weight and a Manhattan distance from the target pixel point to the updated path sketch, wherein the target pixel point is a pixel point outside the updated path sketch and the updated skeleton map in the preset geographic range which is located within the associated geographic range; and setting a map path transition probability of the pixel point in the updated path sketch within the associated geographic range to be 1, and setting a map path transition probability of the pixel point in the updated skeleton map within the associated geographic range to be 0.

In an optional implementation, the generating the target map after updating based on the initial map path after updating comprises: determining, for each pixel point within the associated geographic range, whether the pixel point belongs to a pixel point in an intermediate map path based on a proportion of pixel points belonging to the initial map path among neighborhood pixel points of the pixel point, to obtain the intermediate map path after updating; using the intermediate map path after updating as the initial map path after updating, and repeatedly performing a step of determining the intermediate map path after updating until a preset number of iterations is reached, wherein in each iteration process, a neighborhood pixel point which is not located within the associated geographic range and belongs to the path of the target map before the updating is used as a pixel point belonging to the initial map path, and a neighborhood pixel point which is not located within the associated geographic range and does not belong to the path of the target map before the updating is used as a pixel point not belonging to the initial map path; and updating the target map based on a result of a last iteration.

In an optional implementation, the generating the target map based on the intermediate map path obtained in the last iteration comprises: randomly filling each map decoration element in each connected region in the preset geographic range according to a selection probability corresponding to the map decoration element, to obtain the target map comprising the map decoration element and the intermediate map path.

In a second aspect, an embodiment of the present disclosure further provides a map generation method. The method includes: obtaining a path sketch drawn by a user; generating a target map based on the path sketch: receiving modification information for the path sketch from the user; and updating the target map based on a path portion which is indicated to be modified by the modification information.

In an optional implementation, the method further includes: determining an associated geographic range comprising the path portion which is modified and selected by the user, wherein a portion of the target map outside the associated geographic range is not updated, and wherein the updating the target map based on the path portion which is indicated to be modified by the modification information comprises: updating the target map based on the path portion which is indicated to be modified by the modification information and the associated geographic range.

In an optional implementation, the updating the target map based on the path portion in the path sketch which is indicated to be modified by the modification information is implemented by using the implementations described in the first aspect.

In a third aspect, an embodiment of the present disclosure further provides a map generation device. The device includes: a first obtaining unit, configured to obtain a map path transition probability of each pixel point within a preset geographic range, wherein the map path transition probability is configured to indicate a probability of the pixel point changing from a non-map path pixel point to a map path pixel point; a first generation unit, configured to generate an initial map path based on the map path transition probability; a determination unit, configured to determine, for the pixel point in the preset geographic range, whether the pixel point belongs to a pixel point in an intermediate map path based on a proportion of pixel points belonging to the initial map path among neighborhood pixel points of the pixel point, to obtain the intermediate map path; and a second generation unit, configured to use the intermediate map path as an initial map path after updating, repeatedly perform a step of determining the intermediate map path until a preset number of iterations is reached, and generate a target map based on an intermediate map path obtained after a last iteration.

In a fourth aspect, an embodiment of the present disclosure further provides a map generation device. The device includes: a second obtaining unit, configured to obtain a path sketch drawn by a user; a third generation unit, configured to generate a target map based on the path sketch: a receiving unit, configured to receive modification information for the path sketch from the user; and an updating unit, configured to update the target map based on a path portion which is indicated to be modified.

In a fifth aspect, an embodiment of the present disclosure further provides a computer apparatus. The computer apparatus includes: a processor, a memory, and a bus. The memory has stored thereon machine-readable instructions executable by the processor. When the computer apparatus is running, the processor and the memory communicate through the bus. When executed by the processor, the machine-readable instructions perform the steps in the first aspect or any one of the possible implementations of the first aspect, or perform the steps in the second aspect or any one of the possible implementations of the second aspect.

In a sixth aspect, an embodiment of the present disclosure further provides a computer-readable storage medium, a computer program is stored on the computer-readable storage medium, and when computer program is executed by a processor, the steps in the first aspect or any one of the possible implementations of the first aspect, or the steps in the second aspect or any one of the possible implementations of the second aspect are executed.

In the embodiments of the present disclosure, by obtaining the map path transition probability, each pixel point in the preset range may be changed from a non-map path pixel point to a map path pixel point according to the map path transition probability, so as to obtain the initial map path. Then, whether the pixel point belongs to a pixel point in the intermediate map path may be determined based on the proportion of pixel points belonging to the initial map path among the neighborhood pixel points corresponding to each pixel point in the preset geographic range belonging to the pixel points in the initial map path, so as to obtain the intermediate map path. Then, the process of determining the intermediate map path may be iteratively processed, and the target map is generated based on the intermediate map path obtained after the last iteration.

In order to make the above objects, features, and advantages of the present disclosure more comprehensible, exemplary embodiments are described in detail below with reference to the drawings.

### BRIEF DESCRIPTION OF DRAWINGS

In order to illustrate the technical solutions of the embodiments of the present disclosure more clearly, the drawings required for describing the embodiments will be briefly described below. The drawings herein are incorporated into and constitute a part of this specification, and the drawings illustrate embodiments consistent with the present disclosure and, together with the specification, serve to explain the technical solutions of the present disclosure. It should be understood that the following drawings illustrate only some embodiments of the present disclosure, and therefore should not be construed as limiting the scope of the present disclosure. For those of ordinary skill in the art, other relevant drawings may also be obtained from these drawings without creative effort.

FIG. 1 is a flowchart of a map generation method according to an embodiment of the present disclosure;

FIG. 2 is a schematic diagram of a drawing manner of an obtained path sketch drawn by a user according to an embodiment of the present disclosure;

FIG. 3 is a schematic flowchart of generating a target map according to an embodiment of the present disclosure;

FIG. 4 is a schematic flowchart of another generating a target map according to an embodiment of the present disclosure;

FIG. 5 is a flowchart of another map generation method according to an embodiment of the present disclosure;

FIG. 6 is a schematic diagram of a map generation device according to an embodiment of the present disclosure;

FIG. 7 is a schematic diagram of another map generation device according to an embodiment of the present disclosure;

FIG. 8 is a schematic diagram of a computer apparatus according to an embodiment of the present disclosure; and

FIG. 9 is a schematic diagram of another computer apparatus according to an embodiment of the present disclosure.

### DETAILED DESCRIPTION

In order to make the objectives, technical solutions, and advantages of the embodiments of the present disclosure clearer, the technical solutions in the embodiments of the present disclosure will be described in detail below with reference to the drawings in the embodiments of the present disclosure. Obviously, the described embodiments are only a part of the embodiments of the present disclosure, rather than all of the embodiments. The components of the embodiments of the present disclosure, as generally described and illustrated in the drawings herein, may be arranged and designed in various different configurations. Therefore, the following detailed description of the embodiments of the present disclosure in the drawings is not intended to limit the scope of the disclosed embodiments, but is merely representative of selected embodiments of the present disclosure. Based on the embodiments of the present disclosure, all other embodiments obtained by those skilled in the art without creative effort shall fall within the protection scope of the present disclosure.

It should be noted that the similar reference numerals and letters in the following drawings represent similar items. Therefore, once an item is defined in one drawing, it need not be further defined and explained in subsequent drawings.

The term “and/or” used herein is merely an association relationship, which means that there may be three relationships, for example, A and/or B, which may represent the following three cases: A alone, A and B at the same time, and B alone. In addition, the term “at least one” herein means any one of a plurality of kinds or any combination of at least two of a plurality of kinds, for example, including at least one of A, B, and C, which may represent including any one or more elements selected from a set composed of A, B, and C.

It should be understood that before using the technical solutions disclosed in the embodiments of the present disclosure, the user should be informed of the type, use scope, use scenario, etc. of personal information involved in the present disclosure and obtain the authorization of the user in an appropriate manner according to relevant laws and regulations.

It is found through research that a corresponding game map is usually designed for a game scene, and players are provided with more diversified gameplay based on the game map. In the related art, the game map is mainly drawn manually, which is time-consuming and laborious if the game map is large and the scene is complex. Moreover, in order to improve the accuracy of the drawn game map, the staff who draw the game map are usually required to have certain professional knowledge, which further increases the labor cost of drawing the game map.

Based on the above research, the present disclosure provides a map generation method and device, a computer apparatus, and a storage medium. In the embodiments of the present disclosure, the map path transition probability is obtained, and each pixel point in the preset range is changed from a non-map path pixel point to a map path pixel point according to the map path transition probability, so as to obtain the initial map path. Then, whether the pixel point belongs to a pixel point in the intermediate map path is determined based on the proportion of pixel points belonging to the initial map path among the neighborhood pixel points corresponding to each pixel point in the preset geographic range, so as to obtain the intermediate map path. Then, the process of determining the intermediate map path may be iteratively processed, and the target map is generated based on the intermediate map path obtained in the last iteration.

In the above implementation, the initial map path may be generated by obtained the map path transition probability, and then the pixel points in the initial map path are denoised based on the proportion of pixel points belonging to the initial map path among the neighborhood pixel points corresponding to each pixel point in the preset geographic range, so as to obtain a more accurate intermediate map path after processing. Then, the obtained intermediate map path may be used as the updated initial map path, and the process of obtaining the intermediate map path is repeatedly performed, so that the intermediate map path may be smoothed by iteratively processing the intermediate map path, thereby making the intermediate map path obtained in the last iteration smoother and more beautiful, and further improving the quality and aesthetics of the target map. That is, the embodiments of the present disclosure can automatically and randomly generate a smooth and beautiful map, which not only reduces the labor cost of making the map, but also makes the generated map random and beautiful.

In order to facilitate understanding of this embodiment, a map generation method disclosed in the embodiments of the present disclosure is introduced in detail. The execution body of the map generation method provided in the embodiments of the present disclosure is generally a computer apparatus with certain computing power.

Referring to FIG. 1, which is a flowchart of a map generation method according to an embodiment of the present disclosure, the method includes steps S101 to S107, wherein:
S101: obtaining a map path transition probability of each pixel point within a preset geographic range, wherein the map path transition probability is used to indicate a probability of the pixel point changing from a non-map path pixel point to a map path pixel point.

Here, the preset geographic range may indicate a geographic range where the target map is located, and the preset geographic range may correspond to width information and height information (for example, the width information may be represented by W, and the height information may be represented by H). At this time, the width information W corresponding to the preset geographic range may be set to 50 pixels, and the height information H may be set to 50 pixels. Alternatively, the width information W corresponding to the preset geographic range may be set to 50 pixels, and the height information H may be set to 100 pixels, etc. The preset geographic range is not specifically limited in the present disclosure, and the actual needs shall prevail.

In the embodiment of the present disclosure, before the target map is generated in the preset geographic range, each pixel point in the preset geographic range may be a non-map path pixel point, and the non-map path pixel point may indicate an impassable object in the map, for example, the non-map path pixel point may indicate a rock or water, etc.

In the embodiment of the present disclosure, the map path pixel point may indicate a passable object in the map, for example, the map path pixel point may indicate a floor.

Here, the objects indicated by the non-map path pixel points and the map path pixel points are associated with the application scenario of the generated map, and therefore, the object types of the objects indicated by the non-map path pixel points and the object types of the objects indicated by the map path pixel points are not specifically limited in the embodiments of the present disclosure, as long as they can be implemented.

In the embodiment of the present disclosure, the map path transition probability of each pixel point in the preset geographic range may be the same or different.

For example, in a possible implementation, if the initial map path is automatically generated, the map path transition probability may be preset, and the map path transition probability of each pixel point in the preset geographic range is determined to be the preset map path transition probability. For example, the map path transition probability may be preset to 0.5.

Alternatively, in another possible implementation, the map path transition probability of each pixel point in the preset geographic range may be calculated according to a preset probability calculation rule. In a specific implementation, the preset probability calculation rule may classify pixel points in the preset geographic range to obtain a plurality of categories of pixel points, and set a corresponding map path transition probability for the pixel points in each category.

For example, the user may draw the path sketch by himself/herself. In this case, the pixel points in the preset geographic range may be classified according to a preset absolute map path (for example, a path corresponding to the path sketch drawn by the user) and a preset absolute non-map path (for example, a path corresponding to the skeleton map), and a corresponding map path transition probability is set for the pixel points in each category. At this time, the map path transition probability of a plurality of pixel points corresponding to the absolute map path in the preset geographic range may be set to be 1, the map path transition probability of a plurality of pixel points corresponding to the absolute non-map path in the preset geographic range may be set to be 0, and the map path transition probability corresponding to a pixel point other than the pixel points corresponding to the absolute map path and the absolute non-map path in the preset geographic range is determined according to distance information between the pixel point and the absolute map path. The distance information between the pixel point and the absolute map path may indicate a Manhattan distance between the pixel point and a pixel point closest to the pixel point in the absolute map path.

S103: generating an initial map path based on the map path transition probability.

In the embodiment of the present disclosure, after the map path transition probability of each pixel point in the preset geographic range is obtained, each pixel point in the preset geographic range may be changed from a non-map path pixel point to a map path pixel point according to the map path transition probability, so as to obtain the initial map path after the changing. At this time, the initial map path indicates a path formed by map path pixel points in the preset geographic range.

S105: determining, for each pixel point in the preset geographic range, whether the pixel point belongs to a pixel point in an intermediate map path based on a proportion of pixel points belonging to the initial map path among neighborhood pixel points of the pixel point, to obtain the intermediate map path.

In the embodiment of the present disclosure, the neighborhood pixel points of a pixel point may indicate pixel points in the eight neighborhoods corresponding to the pixel point, and at this time, the number of the neighborhood pixel points of the pixel point is 8.

In the embodiment of the present disclosure, the proportion of the pixel points belonging to the initial map path among neighborhood pixel points of the pixel point, that is, the ratio of the number of the pixel points belonging to the initial map path among neighborhood pixel points of the pixel points to the total number of the neighborhood pixel points, is acquired, when the total number of the neighborhood pixel points is a fixed value (here, 8), which is equivalent to acquiring the number of the neighborhood pixel points of the pixel point that belong to the pixel points in the initial map path.

In the embodiment of the present disclosure, a proportion of pixel points belonging to the initial map path among the neighborhood pixel points of the pixel point in the preset geographic range may be preset, and when it is determined that the proportion of pixel points belonging to the initial map path among the neighborhood pixel points of the pixel point in the preset geographic range is greater than or equal to the preset proportion, it is determined that the pixel point in the preset geographic range belongs to the pixel points in the intermediate map path.

The preset proportion may be 100%, 62.5%, 50%, etc., and the preset proportion is not specifically limited in the embodiments of the present disclosure, as long as the actual needs are met.

Exemplarily, when the neighborhood pixel points are the eight neighborhood pixel points, the preset proportion is 62.5%, that is, the threshold of the number of the pixel points belonging to the initial map path among the neighborhood pixel points of the pixel point is 5. At this time, if it is determined that among the eight neighborhood pixel points corresponding to the pixel point in the preset geographic range, the number of the pixel points belonging to the initial map path is greater than or equal to 5 (that is, 8*62.5%), it is indicated that the pixel point in the preset geographic range belongs to the pixel points in the intermediate map path.

S107: using the intermediate map path as an updated initial map path, repeatedly perform a step of determining the intermediate map path until a preset number of iterations is reached, and generating a target map based on an intermediate map path obtained in a last iteration.

In the embodiment of the present disclosure, after the intermediate map path is obtained, the intermediate map path may be used as the updated initial map path, that is, the step described in S105 is performed again using the intermediate map path as the initial map path.

In the embodiment of the present disclosure, the preset number of iterations may indicate the number of times of repeatedly performing the step of determining the intermediate map path described in S105, for example, the preset number of iterations may be 3, 5, or 10.

In the embodiment of the present disclosure, after the number of times of repeatedly performing the step of determining the intermediate map path described in S105 reaches the preset number of iterations, the map path pixel point in the preset geographic range may be determined based on the intermediate map path obtained in the last iteration, to obtain the target map including the path of the target map.

In the embodiments of the present disclosure, the map path transition probability is obtained, and each pixel point in the preset range is changed from a non-map path pixel point to a map path pixel point according to the map path transition probability, so as to obtain the initial map path. Then, whether the pixel point belongs to a pixel point in the intermediate map path is determined based on the proportion of pixel points belonging to the initial map path among the neighborhood pixel points corresponding to each pixel point in the preset geographic range, so as to obtain the intermediate map path. Then, the process of determining the intermediate map path may be iteratively processed, and the target map is generated based on the intermediate map path obtained in the last iteration.

In the above implementation, the initial map path may be generated by obtained the map path transition probability, and then the pixel points in the initial map path may be denoised based on the proportion of pixel points belonging to the initial map path among the neighborhood pixel points corresponding to each pixel point in the preset geographic range, so as to obtain a more accurate intermediate map path after processing. Then, the obtained intermediate map path may be used as the updated initial map path, and the process of obtaining the intermediate map path is repeatedly performed, so that the intermediate map path may be smoothed by iteratively processing the intermediate map path, thereby making the intermediate map path obtained in the last iteration smoother and more beautiful, and further improving the quality and aesthetics of the target map. That is, the embodiments of the present disclosure can automatically and randomly generate a smooth and beautiful map, which not only reduces the labor cost of making the map, but also makes the generated map random and beautiful.

In an optional implementation, before generating an initial map path based on the map path transition probability, the embodiments of the present disclosure further include the following steps.
Step S21: obtaining a path sketch drawn by a user;
Step S22: generating a skeleton map based on the path sketch, wherein a style of the skeleton map matches a style of the path sketch, and the skeleton map comprises no pixel point belonging to the path sketch; and
Step S23: determining the map path transition probability based on the path sketch and the skeleton map.

In the embodiments of the present disclosure, the path sketch may be obtained by obtaining at least one path drawn by the user based on a brush. At this time, the path sketch may indicate the shape of the intermediate map path obtained in the last iteration.

Here, in order to better determine the topological structure of the path sketch drawn by the user, the brush size of the brush may be preset, so that whether the paths included in the obtained path sketch are connected can be determined more accurately. The preset brush size of the brush may be S, and S is an integer greater than 1, for example, S may be 2 or 3.

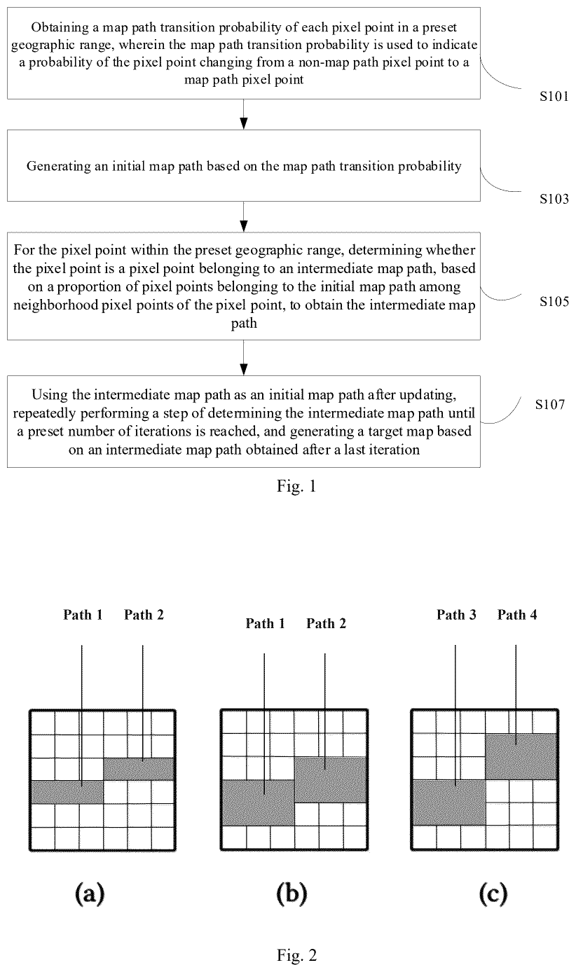

For example, as shown in (a) of FIG. 2, the preset brush size of the brush is 1*1 pixels. At this time, whether the path 1 and the path 2 are connected or not may be presented as the shape shown in (a) of FIG. 2, and therefore, it cannot be accurately determined whether the path 1 and the path 2 are in a connected state. As shown in (b) of FIG. 2, the preset brush size of the brush is 2*2 pixels. At this time, it can be determined that the path 1 and the path 2 are in a connected state. As shown in (c) of FIG. 2, it is a schematic diagram of a path 3 and a path 4 drawn when the brush size of the brush is 2*2 pixels. At this time, it can be determined that the path 3 and the path 4 are not connected.

In the embodiment of the present disclosure, after the path sketch is obtained, the skeleton map may be determined based on a region other than the at least one path in the path sketch. Specifically, skeleton extraction may be performed on the region other than the at least one path in the path sketch to obtain the skeleton map, wherein the skeleton extraction algorithm may be a Zhang-Suen thinning algorithm, or any other skeleton extraction method, which is not specifically limited in the embodiments of the present disclosure, as long as it can be implemented.

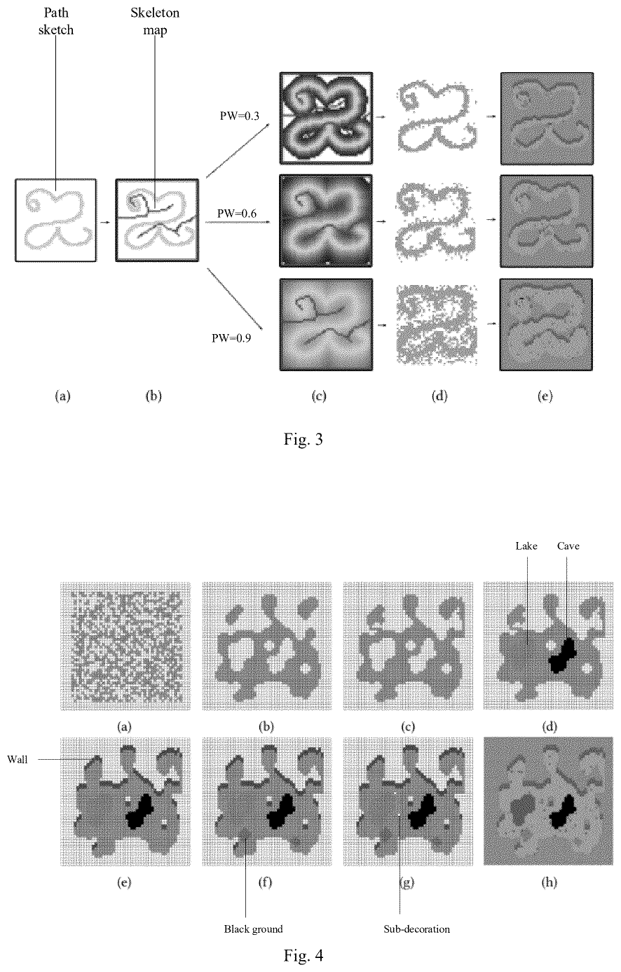

Exemplarily, when the path sketch drawn by the user is shown in (a) of FIG. 3, the skeleton map generated based on the path sketch may be shown in (b) of FIG. 3.

In the embodiment of the present disclosure, after the path sketch and the skeleton map are obtained, the map path transition probability may be determined based on the path sketch and the skeleton map.

Specifically, a map path transition probability of each pixel point outside the path sketch and the skeleton map belonging to the initial map path is determined based on an obtained path width weight and a Manhattan distance from each pixel point outside the path sketch and the skeleton map in the preset geographic range to the path sketch, and a map path transition probability of each pixel point in the path sketch is set to be 1, and a map path transition probability of each pixel point in the skeleton map is set to be 0.

In the embodiment of the present disclosure, the path width weight may indicate a weight used to adjust the width of the path in the map, and the smaller the path width weight, the smaller the width of the path in the map that can be adjusted correspondingly. The value of the path width weight may be any value between [0, 1).

In the embodiment of the present disclosure, the map path transition probability of each pixel point belonging to the initial map path may be determined by using the following formula (1).

$${SVW}_{i , j} = \{ \begin{matrix}1 , & {P}_{i , j} == a pixel point in the path sketch \\ 0 , & {P}_{i , j} == a pixel point in the skeleton map \\ {PW}^{UDF ( {P}_{i , j} )} , & {P}_{i , j} == other\end{matrix} \qquad ( 1 )$$

Here, SVW_{i,j} indicates a map path transition probability corresponding to a pixel point at the i-th row and the j-th column in the preset geographic range; P_{i,j} indicates a pixel point at the i-th row and the j-th column in the preset geographic range, where 1≤i≤W, 1≤j≤H, W is width information corresponding to the preset geographic range, and H is height information corresponding to the preset geographic range; PW indicates an obtained path width weight; UDF (P_{i,j}) indicates a Manhattan distance from P_{i,j} to the path sketch: “P_{i,j}==a pixel point in the path sketch” indicates a pixel point located in the path sketch in the preset geographic range: “P_{i,j}==a pixel point in the skeleton map” indicates a pixel point located in the skeleton map in the preset geographic range.

In the embodiments of the present disclosure, after the map path transition probability of each pixel point in the preset geographic range is determined according to the above formula (1), the initial map path may be generated based on the map path transition probability, and the steps in S105 and S107 are performed based on the initial map path to generate the target map.

Specifically, when the preset proportion is 62.5% and the neighborhood pixel points are the eight neighborhood pixel points, the steps in S105 and S107 may be shown in the following formula (2).

$${G}_{i , j}^{t + 1} = \{ \begin{matrix}map path pixel point , & {P}_{i , j} == \\ & a pixel point in the path sketch \\ non - & {P}_{i , j} == \\ map path pixel point , & a pixel point in the skeleton map \\ A ( {G}_{i , j}^{t} ) \geq 5 ? map path pixel point : & other \\ non - map path pixel point , & \end{matrix} \qquad ( 2 )$$

Here, t+1 indicates the current number of iterations, where t starts from 0. At this time,

$${G}_{i , j}^{1}$$

represents the step in S105 above, that is, the first iteration.

$${G}_{i , j}^{t}$$

is used to indicate a pixel point type of a pixel point located at the i-th row and the j-th column in the target map generated based on the intermediate map path obtained in the current number of iterations (1≤i≤W, 1≤j≤H). At this time, the pixel point type may be the non-map path pixel point or the map path pixel point.

Here,

$${G}_{i , j}^{t + 1}$$

indicates a pixel point type of a pixel point located at the i-th row and the j-th column in the target map generated based on the intermediate map path obtained in the next number of iterations.

$$A ( {G}_{i , j}^{t} )$$

indicates the number of pixel points belonging to the initial map path (or the updated initial map path) among the neighborhood pixel points of a pixel point located at the i-th row and the j-th column in the preset geographic range.

At this time, it can be learned from formula (2) that when P_{i,j} is a pixel point in the path sketch, the pixel point may be determined as the map path pixel point, and at this time, the pixel point belongs to the pixel point in the intermediate map path. When P_{i,j} is a pixel point in the skeleton map, the pixel point may be determined as the non-map path pixel point, and at this time, the pixel point does not belong to the pixel point in the intermediate map path.

It can be learned from formula (2) that in the embodiment of the present disclosure,

$$A ( {G}_{i , j}^{t} ) \geq 5$$

may be used as a constraint condition to determine whether other pixel points that do not belong to the pixel points in the path sketch and the skeleton map in the preset geographic range belong to the pixel points in the intermediate map path. At this time, when it is determined that the pixel point satisfies the condition of

$$A ( {G}_{i , j}^{t} ) \geq 5 ,$$

it is determined that the pixel point is the map path pixel point, that is, the pixel point belongs to the pixel point in the intermediate map path. When it is determined that the pixel point does not satisfy the condition of

$$A ( {G}_{i , j}^{t} ) \geq 5 ,$$

it is determined that the pixel point is the non-map path pixel point, that is, the pixel point does not belong to the pixel point in the intermediate map path.

As an equivalent alternative, a threshold of the neighborhood pixel point being the non-map path pixel point may also be set. At this time, when the proportion or number of pixel points belonging to the non-map path among the neighborhood pixel points of a pixel point exceeds the threshold, the pixel point may be used as the non-map path pixel point. For example, the above threshold may be set to 8 (the total number of the neighborhood pixel points)−5 (the threshold corresponding to the above map path pixel point)=3. For each pixel point in the preset geographic range, if the proportion or number of pixel points belonging to the non-initial map path among the neighborhood pixel points of the pixel point exceeds the threshold (at this time, the number threshold is 3, and the proportion threshold is 37.5%), the pixel point does not belong to the pixel point in the intermediate map path in the above iteration process.

In the above implementation, the skeleton map may be generated by obtained the path sketch drawn by the user, and the path transition probability of each pixel point in the preset geographic range is determined based on the path sketch and the skeleton map, so that the initial map path generated based on the path transition probability is more in line with the drawing requirements of the user.

Further, compared with the method of manually drawing the target map, the above method of generating the target map based on the path sketch drawn by the user reduces the requirements for the drawing personnel who draw the target map, shortens the time of generating the target map, and further saves the time cost and the labor cost.

In the embodiments of the present disclosure, the path sketch may include at least one map element in addition to the at least one path, for example, the map element may be a map entrance (or a map start), a map end, a treasure chest, a character element, etc. The character element may indicate a level enemy or a guide character. At this time, after the target map is generated based on the intermediate map path obtained in the last iteration, an element identification corresponding to each map element may be displayed at a position corresponding to each map element, so that the target map can be made richer and more practical.

In an optional implementation, the determining a map path transition probability of each pixel point outside the path sketch and the skeleton map belonging to the initial map path includes the following process.

A map path transition probability of each pixel point under each of the path width weights is determined based on a plurality of obtained path width weights and the Manhattan distance from each pixel point to the path sketch.

In the embodiments of the present disclosure, a plurality of path width weights may be obtained at the same time, and the map path transition probability of each pixel point in the preset geographic range is calculated under each of the path width weights according to the above formula (1).

Then, a plurality of initial map paths may be generated based on the map path transition probabilities respectively corresponding to the plurality of path width weights.

For example, as shown in FIG. 3, the number of path width weights is 3, and the 3 path width weights are PW1=0.3, PW1=0.6, and PW1=0.9, respectively. At this time, the map path transition probabilities respectively corresponding to the 3 path width weights may be determined, at this time, the map path transition probabilities are determined for the 3 path width weights, and the heat map in the preset geographic range determined based on the map path transition probability may be shown in (c) of FIG. 3.

Then, the initial map path corresponding to each of the 3 path width weights may be generated based on the 3 path width weights, to obtain a plurality of initial map paths as shown in (d) of FIG. 3.

In the embodiment of the present disclosure, the step in S105 and S107 may be performed for each of the initial map paths shown in (d) of FIG. 3, to obtain the path of the target map corresponding to each of the initial map paths shown in (c) of FIG. 3. Here, the path of the target map may be understood as the intermediate map path without the map path portion that is not connected.

In the embodiment of the present disclosure, the paths of the target maps respectively corresponding to the plurality of initial map paths may be displayed, and the map path selected by the user from the plurality of target map paths is determined in response to a selection operation of the user for the plurality of paths of target maps.

At this time, the target map may be generated based on the selected map path.

It can be learned from the above description that in the embodiments of the present disclosure, a plurality of path width weights may be obtained at the same time, so as to generate the paths of the target maps corresponding to the path width weights (that is, obtain a plurality of paths of the target maps). Then, the plurality of paths of target maps may be displayed, and the map path selected by the user from the plurality of paths of the target maps is determined, so as to generate the target map based on the selected map path. In the above implementation, the effect diagrams of the plurality of paths of the target maps may be displayed for the user at the same time, so as to reduce the number of times that the user adjusts the path width weight to generate the path of the target map, thereby improving the efficiency of obtaining the target map.

At the same time, when the path widths corresponding to the plurality of paths of target maps which are displayed cannot meet the needs of the user, the value of the path width weight for adjusting the path of the target map next time may be determined faster and more accurately, based on the path width weights corresponding to the plurality of paths of target maps which are displayed, so that the next path width weight may be obtained faster, to further improve the efficiency of obtaining the target map that meets the needs of the user.

In an optional implementation, after the generating the target map, the embodiments of the present disclosure may further update the target map based on a path portion which is indicated to be modified, in response to receiving modification information for the path sketch from the user.

In the embodiments of the present disclosure, the modification information for the path sketch from the user may be understood as modification information of the path sketch which is obtained after the user modifies at least a portion of regions in the path sketch, or may be a path sketch redrawn by the user. At this time, the modification information for the path sketch from the user may be determined based on the path sketch redrawn by the user.

In the embodiment of the present disclosure, the modification information for the path sketch may indicate a path portion in the path sketch that is modified, and at this time, there may be one or more modified path portions.

Then, the target map may be updated based on the path portion which is indicated to be modified by the modification information, which may be specifically described as the following steps.

Step S31: determining an updated path sketch based on the path portion which is indicated to be modified by the modification information, and generating an updated skeleton map based on the updated path sketch; and determining an associated geographic range corresponding to the modified path portion.

Step S32: updating the map path transition probability based on the updated path sketch, the updated skeleton map, and the associated geographic range, wherein a map path transition probability of each pixel point located in the path of the target map before the updating and outside the associated geographic range is set to be 1, and a map path transition probability of each pixel point not located in the path of the target map before the updating is set to be 0.

Step S33: generating an updated initial map path based on the updated map path transition probability, and generating an updated target map based on the updated initial map path.

In the embodiments of the present disclosure, in the case where the updated path sketch may be determined based on the path portion which is indicated to be modified, the modified path portion may indicate a portion which is performed modification in the obtained path sketch drawn by the user, and at this time, the modified path sketch may be determined as the updated path sketch. Alternatively, in the case where the modified path portion is determined based on the path sketch redrawn by the user, the redrawn path sketch may be determined as the updated path sketch.

In the embodiments of the present disclosure, after the updated path sketch is determined, the updated skeleton map may be generated based on the updated path sketch. At this time, the manner of generating the updated skeleton map based on the updated path sketch is the same as the manner of generating the skeleton map based on the path sketch in the above step S22, that is, skeleton extraction may be performed on a region other than the at least one path in the updated path sketch to obtain the updated skeleton map, wherein the skeleton extraction algorithm may be a Zhang-Suen thinning algorithm or any other skeleton extraction method, which is not specifically limited in the embodiments of the present disclosure, as long as it can be implemented.

In the embodiments of the present disclosure, the associated geographic range may also be determined based on the path portion which is indicated to be modified.

In a possible implementation, the associated geographic range may be a range pre-encircled for the modified path portion when the user modifies the path sketch. At this time, the range may be determined as the associated geographic range.

In another possible implementation, a minimum circular region or a minimum rectangular region (or other regions with any shape) covering the modified path portion may also be used as an automatically encircled range, and the automatically encircled range is determined as the associated geographic range. The manner of determining the associated geographic range is not specifically limited in the embodiments of the present disclosure, as long as it can be implemented.

In the embodiments of the present disclosure, after the updated path sketch, the updated skeleton map, and the associated geographic range are obtained, the map path transition probability may be updated.

Specifically, first, updated map path transition probabilities corresponding to respective target pixel points are determined based on the path width weight and Manhattan distances from the respective target pixel points located within the associated geographic range to the updated path sketch, wherein the respective target pixel points are pixel points outside the updated path sketch and the updated skeleton map in the preset geographic range.

At the same time, the map path transition probability of each pixel point in the updated path sketch within the associated geographic range may be set to be 1, and the map path transition probability of each pixel point in the updated skeleton map within the associated geographic range may be set to be 0.

At this time, after the updated map path transition probability is obtained according to the above manner, the updated initial map path may be generated based on the updated map path transition probability, and the updated target map is generated based on the updated initial map path.

In this case, the process of generating the updated target map based on the updated initial map path may be described as the following steps.

Step S41: determining, for each pixel point within the associated geographic range, whether the pixel point belongs to a pixel point in an intermediate map path, based on a proportion of pixel points belonging to the initial map path among neighborhood pixel points of the pixel point, to obtain the updated intermediate map path.

Step S42: using the updated intermediate map path as an updated initial map path, and repeatedly perform a step of determining the updated intermediate map path until a preset number of iterations is reached.

In each iteration process, a neighborhood pixel point that is not located within the associated geographic range and belongs to the path of the target map before the updating is used as a pixel point belonging to the initial map path, and a neighborhood pixel point that is not located within the associated geographic range and does not belong to the path of the target map before the updating is used as a pixel point not belonging to the initial map path.

Step S43: updating the target map based on a result of the last iteration.

Here, the neighborhood pixel points may indicate the eight neighborhood pixel points as described above.

Here, the proportion of pixel points belonging to the initial map path among neighborhood pixel points is the same as the above preset proportion, for example, the proportion may be 100%, 62.5%, or 50%, etc.

In the above implementation, the target map may be updated (or modified) by obtaining the updated path sketch of the user, so that the generated target map can be conveniently and quickly adjusted, thereby improving the quality of the obtained target map.

In an optional implementation, for S107: generating a target map based on an intermediate map path obtained after a last iteration, the following steps are specifically included.

Step S51: if there are a plurality of map path portions which are not connected in the intermediate map path, starting a plurality of agent threads.

Step S52: determining a current to-be-connected map path portion from the plurality of map path portions, randomly selecting one pixel point from the current to-be-connected map path portion as a start pixel point for each of the agent threads, and randomly generating one candidate path from the start pixel point to another map path portion; and using a shortest path in the candidate paths generated by the plurality of agent threads as the path of the target map.

Step S53: repeating a step of determining the current to-be-connected map path portion from the plurality of map path portions until connection of the plurality of map path portions are established, to obtain the path of the target map.

In the embodiments of the present disclosure, the agent thread may be used to connect two map path portions that are not connected. At this time, the number of the agent threads that are started may be 10 or 15, etc., and the number of the plurality of agent threads that are started is not specifically limited in the embodiments of the present disclosure.

In the embodiments of the present disclosure, after the plurality of agent threads are started, two map path portions to-be-connected may be determined first. It is assumed that the two map path portions are Øᵢ and Øⱼ, respectively, and the current to-be-connected map path portion is Øᵢ, and the other map path portion to be reached is Øⱼ. Then, the start pixel point of each of the agent threads may be determined from the current to-be-connected map path portion Øᵢ. Then, a candidate path from the start pixel point to the first pixel point belonging to the other map path portion Øⱼ may be generated based on the plurality of started agent threads, respectively, to obtain a plurality of candidate paths corresponding to the plurality of agent threads.

At this time, the shortest path in the plurality of candidate paths may be used as the path of the target map, so as to connect the two map path portions to-be-connected.

In the embodiments of the present disclosure, the process described in the above steps S51 and S52 may be repeatedly performed until the plurality of map path portions that are not connected in the intermediate map path are connected to obtain the path of the target map.

In the above implementation, when it is detected that there are a plurality of map path portions that are not connected in the intermediate map path, the connection between the plurality of map path portions may be achieved by starting a plurality of agent threads, so that the path of the target map can be made more complete, thereby improving the quality of the target map.

In an optional implementation, in a case that the path sketch drawn by the user is not obtained before generating the initial map path based on the map path transition probability, the preset map path transition probability may be obtained, and the initial map path is generated based on the map path transition probability.

For example, when the preset map path transition probability is 0.5, the initial map path generated according to the map path transition probability may be shown in (a) of FIG. 4.

Then, the step in S105 to S107 may be performed to iteratively process the initial map path. At this time, the intermediate map path after the last iteration may be shown in (b) of FIG. 4.

It can be understood from (b) of FIG. 4 that there are a plurality of map path portions that are not connected in the intermediate map path, and at this time, the plurality of map path portions that are not connected which are included in the intermediate map path as shown in (b) of FIG. 4 may be connected according to the steps described in the above steps S51 to S53, and the path of the target map as shown in (c) of FIG. 4 may be obtained after the connection.

In the embodiments of the present disclosure, after the intermediate map path without the map path portion being not connected is obtained, the target map may be generated based on the intermediate map path.

In this process, in the embodiments of the present disclosure, each map decoration element may also be randomly filled in each connected region in the preset geographic range according to a selection probability corresponding to each map decoration element, to obtain the target map including each map decoration element and the intermediate map path.

In the embodiments of the present disclosure, the content of the obtained target map may be enriched by the map decoration element, for example, the map decoration element may be at least one of the following: a tree, a forest, a lake, a cave, a wormhole, a black ground, a carpet, a wall, a mountain, an animal, etc.

In the embodiments of the present disclosure, the same selection probability or different selection probabilities may be set for different types of map decoration elements, and each map decoration element is randomly filled in the preset geographic range based on each map decoration element. For example, when the map decoration element is a lake and a cave, the selection probabilities corresponding to the lake and the cave may be set to 25%, or the selection probability corresponding to the lake may be set to 25%, and the selection probability corresponding to the cave may be set to 50%.

In the embodiments of the present disclosure, different types of map decoration elements may be correspondingly filled into different regions in the preset geographic range.

For example, when the map decoration element corresponds to a single connected region (for example, the map decoration element is a cave or a lake), the map decoration element corresponding to this single connected region may be filled into each connected region corresponding to the non-map path pixel point in the preset geographic range. As shown in (d) of FIG. 4, it is a target map including each map decoration element and the intermediate map path obtained after filling each map decoration element in the preset geographic range.

For another example, when the map decoration element is a wall, the filling region of the wall in the preset geographic range may be determined according to the shooting angle of the virtual camera. At this time, after the wall is added to the target map shown in (d) of FIG. 4, the target map shown in (c) of FIG. 4 may be obtained.

For another example, when the map decoration element is a black ground, the map decoration element may be filled into the region where the map path pixel point is located in the preset range according to the selection probability. At this time, the size of the black ground may be determined based on a breadth-first search method. At this time, after the black ground is added to the target map shown in (c) of FIG. 4, the target map shown in (f) of FIG. 4 may be obtained.

In the embodiments of the present disclosure, at least one sub-decoration matching the application scenario of the target map may also be preset, and the at least one sub-decoration is randomly filled into the region where the map path pixel point is located in the preset range according to the selection probability corresponding to the sub-decoration. For example, the sub-decoration may be a road sign, a flower, grass, a mural on the wall, etc. At this time, after the at least one sub-decoration is added to the target map shown in (f) of FIG. 4, the target map shown in (g) of FIG. 4 may be obtained.

In the embodiments of the present disclosure, after each sub-decoration is filled into the preset geographic range, it may be detected by using a local detection algorithm whether each sub-decoration blocks the path in the target map, and the sub-decoration is removed when it is determined that the sub-decoration blocks the path in the target map.

In the embodiments of the present disclosure, after the target map is generated, the geometric map corresponding to the target map may be created based on the Marching squares algorithm, so that the geometric shape corresponding to the target map may be obtained. For example, after the geometric map corresponding to the target map shown in (g) of FIG. 4 is created, the geometric shape of the target map shown in (h) of FIG. 4 may be obtained.

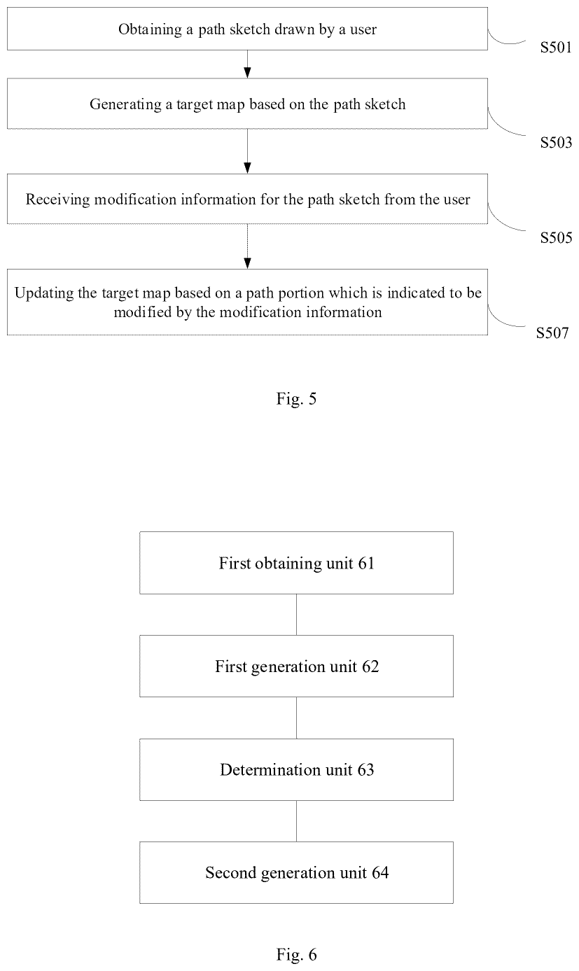

Referring to FIG. 5, which is a flowchart of another map generation method according to an embodiment of the present disclosure. At this time, the map generation method may be applied to a map editor. At this time, the method includes steps S501 to S507, wherein:
Step S501: obtaining a path sketch drawn by a user;
Step S503: generating a target map based on the path sketch;
Step S505: receiving modification information for the path sketch from the user; and
Step S507: updating the target map based on a path portion which is indicated to be modified.

Here, the path sketch drawn by the user may include a passable path in the map, wherein the path may be a straight line path, a curved path, a right-angled path, etc. The shape of the path included in the path sketch is not specifically limited in the embodiments of the present disclosure, as long as the actual needs are met.

In the embodiments of the present disclosure, the target map may be generated based on the path sketch drawn by the user according to the map generation method described in above S101 to S107, which will not be described in detail here.

In the embodiments of the present disclosure, when the user is not satisfied with the target map, the modification information for the path sketch from the user may be received, and based on the modification information, the path portion which is indicated to be modified is searched and the target map is updated, so that the secondary editing of the target map may be realized to obtain the target map that is more in line with the needs of the user.

In a specific implementation, the associated geographic range including the modified path portion which is encircled by the user may be determined first, wherein the target map portion outside the associated geographic range is not updated.

The associated geographic range including the modified path portion which is encircled by the user may be a range pre-encircled by the user for the modified path portion. At this time, the pre-encircled range may be understood as a range encircled by the user for the path sketch. Alternatively, the associated geographic range may also be a range automatically encircled based on the minimum circular region or the minimum rectangular region (or other regions with any shape) covering the modified path portion. At this time, the modified path portion may be a modified path portion obtained after the user modifies at least a portion of paths in the path sketch by clicking (or selecting). The method of determining the associated geographic range is not specifically limited in the embodiments of the present disclosure, as long as it can be implemented.

Then, the target map may be updated based on the path portion which is indicated to be modified by the modification information and the associated geographic range.

Here, the updating the target map based on the path portion which is indicated to be modified by the modification information is implemented by using the method described in the above steps S31 to S43, which will not be described in detail here.

In the above implementation, the corresponding target map may be automatically generated by obtaining the path sketch drawn by the user, thereby saving the time cost and the labor cost. At the same time, when the generated target map does not meet the needs of the user, the user may also update the path sketch. At this time, the path portion which is indicated to be modified by the modification information may be updated by receiving the update information (that is, the modification information) of the user for the path sketch, so as to update the target map. In this implementation, the target map may be updated in a targeted manner (that is, the modified path portion is updated), thereby saving resources and improving efficiency.

It may be understood by those skilled in the art that in the above method of the specific implementation, the writing order of the steps does not mean a strict execution order and constitutes any limitation to the implementation process, and the specific execution order of the steps should be determined by their functions and possible internal logic.

Based on the same inventive concept, the embodiments of the present disclosure also provide a map generation device corresponding to the map generation method. Since the principle of solving the problem by the device in the embodiments of the present disclosure is similar to the above map generation method in the embodiments of the present disclosure, the implementation of the device may refer to the implementation of the method, and the repeated parts will not be repeated.

Referring to FIG. 6, which is a schematic diagram of a map generation device according to an embodiment of the present disclosure, the device includes: an obtaining unit 61, a first generation unit 62, a determination unit 63, and a second generation unit 64, wherein:
the first obtaining unit 61 is configured to obtain a map path transition probability of each pixel point within a preset geographic range, wherein the map path transition probability is used to indicate a probability of the pixel point changing from a non-map path pixel point to a map path pixel point;
the first generation unit 62 is configured to generate an initial map path based on the map path transition probability;
the determination unit 63 is configured to determine, for each pixel point in the preset geographic range, whether the pixel point belongs to a pixel point in an intermediate map path based on a proportion of pixel points belonging to the initial map path among neighborhood pixel points of the pixel point, to obtain the intermediate map path; and
the second generation unit 64 is configured to use the intermediate map path as an updated initial map path, repeatedly perform the step of determining the intermediate map path until a preset number of iterations is reached, and generate a target map based on an intermediate map path obtained after a last iteration.

In the embodiments of the present disclosure, by obtaining the map path transition probability, each pixel point in the preset range may be changed from a non-map path pixel point to a map path pixel point according to the map path transition probability, so as to obtain the initial map path. Then, whether the pixel point belongs to a pixel point in the intermediate map path may be determined based on the proportion of the pixel points belonging to the initial map path among the neighborhood pixel points corresponding to each pixel point in the preset geographic range, so as to obtain the intermediate map path. Then, the process of determining the intermediate map path may be iteratively processed, and the target map is generated based on the intermediate map path obtained after the last iteration.

In the above implementation, the initial map path may be generated by obtaining the map path transition probability, and then the pixel points in the initial map path may be denoised based on the proportion of the pixel points belonging to the initial map path among the neighborhood pixel points corresponding to each pixel point in the preset geographic range, so as to obtain a more accurate intermediate map path after processing. Then, the obtained intermediate map path may be used as the updated initial map path, and the process of obtaining the intermediate map path is repeatedly performed, so that the intermediate map path may be performed the smoothing processing by iteratively processing the intermediate map path, thereby making the intermediate map path obtained after the last iteration smoother and more beautiful, and further improving the quality and aesthetics of the target map. That is, the embodiments of the present disclosure can automatically and randomly generate a smooth and beautiful map, which not only reduces the labor cost of making the map, but also makes the generated map having randomness and aesthetics.

In a possible implementation, the second generation unit 64 is further configured to: if there are a plurality of map path portions that are not connected in the intermediate map path, start a plurality of agent threads; determine a current to-be-connected map path portion from the plurality of map path portions, randomly select one pixel point from the current to-be-connected map path portion as a start pixel point for each of the agent threads, and randomly generate one candidate path from the start pixel point to another map path portion; and use a shortest path in the candidate paths generated by the plurality of agent threads as the path of the target map; and repeat the step of determining the current to-be-connected map path portion from the plurality of map path portions until the plurality of map path portions are connected, to obtain the path of the target map.

In a possible implementation, the device is further configured to: obtain a path sketch drawn by a user; generate a skeleton map based on the path sketch, wherein a style of the skeleton map matches a style of the path sketch, and the skeleton map comprises no pixel point belonging to the path sketch; and determine the map path transition probability based on the path sketch and the skeleton map.

In an optional implementation, the device is further configured to: determine a map path transition probability of each pixel point outside the path sketch and the skeleton map belonging to the initial map path, based on an obtained path width weight and a Manhattan distance from each pixel point outside the path sketch and the skeleton map and in the preset geographic range to the path sketch, and set a map path transition probability of each pixel point in the path sketch to be 1, and set a map path transition probability of each pixel point in the skeleton map to be 0.

In a possible implementation, the device is further configured to: determine a map path transition probability of each pixel point under each of the plurality of path width weights based on a plurality of obtained path width weights and the Manhattan distance from each pixel point to the path sketch, wherein the generating an initial map path based on the map path transition probability includes: generating a plurality of initial map paths based on the map path transition probabilities respectively corresponding to the plurality of path width weights; and after obtaining the paths of the target maps respectively corresponding to the plurality of initial map paths, the method further includes: displaying the plurality of paths of target maps, and determining the path of the target map selected by the user from the plurality of paths of target maps.

In a possible implementation, the device is further configured to: after generating the target map, in response to receiving modification information for the path sketch from the user, updating the target map based on a path portion which is indicated to be modified by the modification information.

In a possible implementation, the device is further configured to determine an updated path sketch based on the modification information for the path sketch, and generate an updated skeleton map based on the updated path sketch; and determine an associated geographic range corresponding to the modified path portion; update the map path transition probability based on the updated path sketch, the updated skeleton map, and the associated geographic range, wherein a map path transition probability of each pixel point located in the path of the target map before the updating and outside the associated geographic range is set to be 1, and a map path transition probability of each pixel point not located in the path of the target map before the updating is set to be 0; and generate an updated initial map path based on the updated map path transition probability, and generate an updated target map based on the updated initial map path.

In a possible implementation, the device is further configured to determine updated map path transition probabilities corresponding to respective target pixel points based on the path width weight and Manhattan distances from the respective target pixel points to the updated path sketch, wherein the respective target pixel points are the pixel points outside the updated path sketch and the updated skeleton map in the preset geographic range which located within the associated geographic range; and set the map path transition probability of each pixel point in the updated path sketch within the associated geographic range to be 1, and set the map path transition probability of each pixel point in the updated skeleton map within the associated geographic range to be 0.

In a possible implementation, the device is further configured to determine, for each pixel point within the associated geographic range, whether the pixel point belongs to a pixel point in an intermediate map path based on a proportion of pixel points belonging to the initial map path among neighborhood pixel points of the pixel point, to obtain the updated intermediate map path: use the updated intermediate map path as an updated initial map path, and repeatedly perform the step of determining the updated intermediate map path until a preset number of iteration times is reached, wherein in each iteration process, a neighborhood pixel point that is not located within the associated geographic range and belongs to the path of the target map before the updating is used as a pixel point belonging to the initial map path, and a neighborhood pixel point that is not located within the associated geographic range and does not belong to the path of the target map before the updating is used as a pixel point not belonging to the initial map path; and update the target map based on a result of the last iteration.

In a possible implementation, the second generation unit 64 is further configured to: randomly fill respective map decoration elements in respective connected regions in the preset geographic range according to selection probabilities corresponding to respective map decoration elements, to obtain the target map including respective map decoration elements and the intermediate map path.

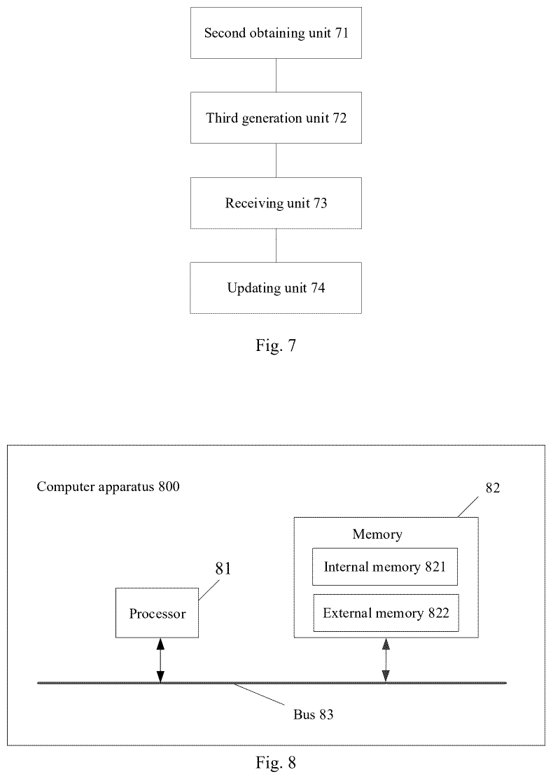

Referring to FIG. 7, which is a schematic diagram of another map generation device according to an embodiment of the present disclosure, the device includes: a second obtaining unit 71, a third generation unit 72, a receiving unit 73, and an updating unit 74, wherein:
the second obtaining unit 71 is configured to obtain a path sketch drawn by a user;
the third generation unit 72 is configured to generate a target map based on the path sketch;
the receiving unit 73 is configured to receive modification information for the path sketch from the user; and
the updating unit 74 is configured to update the target map based on a path portion which is indicated to be modified.

In the above implementation, the corresponding target map may be automatically generated by obtaining the path sketch drawn by the user, thereby saving the time cost and the labor cost. At the same time, when the generated target map does not meet the needs of the user, the user may also update the path sketch. At this time, the path portion which is indicated to be modified by the modification information may be updated by receiving the update information (that is, the modification information) of the user for the path sketch, so as to update the target map. In this implementation, the target map may be updated in a targeted manner (that is, the path portion which is indicated to be modified is updated), thereby saving resources and improving efficiency.

In a possible implementation, the device is further configured to: determine an associated geographic range including the modified path portion encircled by the user, wherein a portion of the target map outside the associated geographic range is not updated; and updating the target map based on the path portion which is indicated to be modified by the modification information includes: updating the target map based on the path portion which is indicated to be modified by the modification information and the associated geographic range.

In a possible implementation, the above updating the target map based on the path portion which is indicated to be modified by the modification information is implemented by using the method of the above implementation.

The description of the processing flows of respective modules in the device and the interaction flows between the modules may refer to the relevant description in the above method embodiments, which will not be described in detail here.

Corresponding to the map generation method in FIG. 1, the embodiments of the present disclosure also provide a computer apparatus 800. As shown in FIG. 8, which is a schematic structural diagram of the computer apparatus 800 provided by the embodiments of the present disclosure, including:
a processor 81, a memory 82, and a bus 83, wherein the memory 82 is used to store execution instructions, including an internal memory 821 and an external memory 822. The internal memory 821 is also called an inner memory, which is used to temporarily store the operation data in the processor 81 and a data which is exchanged with an external memory 822 such as a hard disk. The processor 81 exchanges data with the external memory 822 through the internal memory 821. When the computer apparatus 800 runs, the processor 81 and the memory 82 communicate through the bus 83, so that the processor 81 executes the following instructions:
obtaining a map path transition probability of each pixel point within a preset geographic range, wherein the map path transition probability is used to indicate a probability of the pixel point changing from a non-map path pixel point to a map path pixel point;
generating an initial map path based on the map path transition probability;
determining, for each pixel point in the preset geographic range, whether the pixel point belongs to a pixel point in an intermediate map path, based on a proportion of pixel points belonging to the initial map path among neighborhood pixel points of the pixel point, to obtain the intermediate map path; and
using the intermediate map path as an updated initial map path, repeatedly performing the step of determining the intermediate map path until a preset number of iterations is reached, and generating a target map based on an intermediate map path obtained after a last iteration.

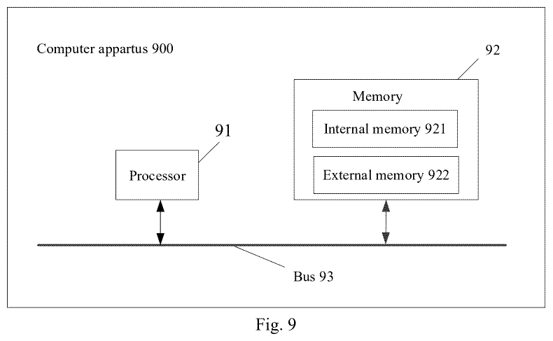

Corresponding to the map generation method in FIG. 5, the embodiments of the present disclosure also provide another computer apparatus 900. As shown in FIG. 9, which is a schematic structural diagram of the computer apparatus 900 provided by the embodiments of the present disclosure, including:
a processor 91, a memory 92, and a bus 93, wherein the memory 92 is used to store execution instructions, including an internal memory 921 and an external memory 922. The internal memory 91 is also called an inner memory, which is used to temporarily store the operation data in the processor 91 and a data which is exchanged with an external memory 922 such as a hard disk. The processor 91 exchanges data with the external memory 922 through the internal memory 921. When the computer apparatus 900 runs, the processor 91 and the memory 92 communicate through the bus 93, so that the processor 91 executes the following instructions:
obtaining a path sketch drawn by a user;
generating a target map based on the path sketch;
receiving modification information for the path sketch from the user; and
updating the target map based on a path portion which is indicated to be modified by the modification information.

The embodiments of the present disclosure also provide a computer-readable storage medium, wherein a computer program is stored on the computer-readable storage medium, and when the computer program is run by a processor, the steps of the map generation method described in the above method embodiments are executed. The storage medium may be a volatile or non-volatile computer-readable storage medium.

The embodiments of the present disclosure also provide a computer program product, wherein the computer program product carries program codes, and the instructions included in the program codes may be used to execute the steps of the map generation method described in the above method embodiments, which may be specifically referred to the above method embodiments, and will not be repeated here.

The above computer program product may be implemented in hardware, software, or a combination thereof. In an optional embodiment, the computer program product is embodied as a computer storage medium. In another optional embodiment, the computer program product is embodied as a software product, such as a software development kit (SDK), etc.

It can be clearly understood by those skilled in the art that for the convenience and conciseness of description, the specific working process of the above-described system and device may refer to the corresponding process in the foregoing method embodiments, and will not be repeated here. In the several embodiments provided in the present disclosure, it should be understood that the disclosed system, device, and method may be implemented in other ways. The device embodiments described above are only schematic, for example, the division of the unit is only a logical function division, and there may be other division methods in actual implementation. For another example, a plurality of units or components may be combined or integrated into another system, or some features may be omitted or not executed. In addition, the mutual coupling or direct coupling or communication connection shown or discussed may be through some communication interfaces, and the indirect coupling or communication connection of the device or unit may be electrical, mechanical or other forms.

The units described as separate components may or may not be physically separated, and the components as unit displaying may or may not be physical units, that is, they may be located in one place, or may be distributed to a plurality of network units. Some or all of the units may be selected according to actual needs to achieve the objectives of the solutions of the embodiments.

In addition, the functional units in the embodiments of the present disclosure may be integrated into one processing unit, or each unit may exist alone physically, or two or more units may be integrated into one unit.

The function may be stored in a non-volatile computer-readable storage medium executable by a processor when implemented in the form of a software functional unit and sold or used as an independent product. Based on such understanding, the technical solution of the present disclosure substantially or a portion of the technical solution of the present disclosure which contribute to the prior art or a portion of the technical solution may be embodied in the form of a software product, which is stored in a storage medium and includes instructions for causing a computer apparatus (which may be a personal computer, a server, or a network apparatus, etc.) to execute all or a portion of the steps of the methods described in the embodiments of the present disclosure. The above-mentioned storage medium includes various media that can store program codes, such as a USB flash drive, a mobile hard disk, a read-only memory (Read-Only Memory, ROM), a random access memory (Random Access Memory, RAM), a magnetic disk, or an optical disc.

Finally, it should be noted that the above embodiments are only specific implementations of the present disclosure, which are used to illustrate the technical solutions of the present disclosure, but not to limit them. The protection scope of the present disclosure is not limited to this. Although the present disclosure has been described in detail with reference to the foregoing embodiments, those of ordinary skilled in the art should understand that any person skilled in the art may still modify the technical solutions described in the foregoing embodiments or may easily think of changes within the technical scope disclosed by the present disclosure, or equivalently replace some of the technical features; and these modifications, changes, or replacements do not make the essence of the corresponding technical solutions deviate from the spirit and scope of the technical solutions of the embodiments of the present disclosure, and all of them should be included in the protection scope of the present disclosure. Therefore, the protection scope of the present disclosure should be subject to the protection scope of the claims.

1. A map generation method, comprising:
obtaining a map path transition probability of each pixel point within a preset geographic range, wherein the map path transition probability is used to indicate a probability of the pixel point changing from a non-map path pixel point to a map path pixel point;
generating an initial map path based on the map path transition probability;
for each pixel point within the preset geographic range, determining whether the pixel point is a pixel point belonging to an intermediate map path, based on a proportion of pixel points belonging to the initial map path among neighborhood pixel points of the pixel point, to obtain the intermediate map path; and
using the intermediate map path as an initial map path after updating, repeatedly performing a step of determining the intermediate map path until a preset number of iterations is reached, and generating a target map based on an intermediate map path obtained after a last iteration.

2. The method according to claim 1, wherein the generating a target map based on an intermediate map path obtained after a last iteration comprises:
when a plurality of map path portions are not connected in the intermediate map path, starting a plurality of agent threads;
determining a current to-be-connected map path portion from the plurality of map path portions, and for each of the plurality of agent threads, randomly selecting one pixel point from the current to-be-connected map path portion as a start pixel point, and randomly generating one candidate path from the start pixel point to another map path portion; and using a shortest path in the candidate paths generated by the plurality of agent threads as a path of the target map; and
repeating a step of determining the current to-be-connected map path portion from the plurality of map path portions until connection for the plurality of map path portions are established, to obtain the path of the target map.

3. The method according to claim 1, wherein before generating an initial map path based on the map path transition probability, the method further comprises:
obtaining a path sketch drawn by a user;
generating a skeleton map based on the path sketch, wherein a style of the skeleton map matches a style of the path sketch, and the skeleton map comprises no pixel point belonging to the path sketch; and
determining the map path transition probability based on the path sketch and the skeleton map.

4. The method according to claim 3, wherein the determining the map path transition probability based on the path sketch and the skeleton map comprises:
determining a map path transition probability of each pixel point outside the path sketch and the skeleton map belonging to the initial map path, based on an obtained path width weight and a Manhattan distance from the pixel point outside the path sketch and the skeleton map and within the preset geographic range to the path sketch, setting a map path transition probability of the pixel point in the path sketch to be 1, and setting a map path transition probability of the pixel point in the skeleton map to be 0.

5. The method according to claim 4, wherein the determining a map path transition probability of each pixel point outside the path sketch and the skeleton map belonging to the initial map path comprises: based on a plurality of path width weights which are obtained and the Manhattan distance from the pixel point to the path sketch, determining a map path transition probability of the pixel point under each of the plurality of path width weights, respectively;
the generating an initial map path based on the map path transition probability comprises: generating a plurality of initial map paths based on map path transition probabilities respectively corresponding to the plurality of path width weights, and
after obtaining a plurality of paths of target maps respectively corresponding to the plurality of initial map paths, the method further comprises: displaying the plurality of paths of target maps, and determining a path of target map selected by the user from the plurality of paths of target maps.

6. The method according to claim 3, wherein after the generating a target map, the method further comprises:
in response to receiving modification information for the path sketch from the user, updating the target map based on a path portion which is indicated to be modified by the modification information.

7. The method according to claim 6, wherein the updating the target map based on a path portion which is indicated to be modified by the modification information comprises:
determining an updated path sketch based on the path portion which is indicated to be modified by the modification information, and generating an updated skeleton map based on the updated path sketch; and determining an associated geographic range corresponding to the path portion which is indicated to be modified;
updating the map path transition probability based on the updated path sketch, the updated skeleton map, and the associated geographic range, wherein setting a map path transition probability of each pixel point located in the path of the target map before the updating and outside the associated geographic range to be 1, and setting a map path transition probability of each pixel point not located in the path of the target map before the updating to be 0; and
generating an initial map path after updating based on the map path transition probability after updating, and generating a target map after updating based on the initial map path after updating.

8. The method according to claim 7, wherein the updating the map path transition probability based on the updated path sketch, the updated skeleton map, and the associated geographic range comprises:
determining an updated map path transition probability corresponding to each target pixel point, based on a path width weight and a Manhattan distance from the target pixel point to the updated path sketch, wherein the target pixel point is a pixel point outside the updated path sketch and the updated skeleton map and within the preset geographic range which is located within the associated geographic range; and
setting a map path transition probability of the pixel point in the updated path sketch within the associated geographic range to be 1, and setting a map path transition probability of the pixel point in the updated skeleton map within the associated geographic range to be 0.

9. The method according to claim 7, wherein the generating a target map after updating based on the initial map path after updating comprises:
for each pixel point within the associated geographic range, determining whether the pixel point is a pixel point belonging to an intermediate map path, based on a proportion of pixel points belonging to the initial map path among neighborhood pixel points of the pixel point, to obtain the intermediate map path after updating;
using the intermediate map path after updating as the initial map path after updating, and repeatedly performing a step of determining the intermediate map path after updating until a preset number of iterations is reached, wherein in each iteration process, a neighborhood pixel point which is not located within the associated geographic range and belongs to the path of the target map before the updating is used as a pixel point belonging to the initial map path, and a neighborhood pixel point which is not located within the associated geographic range and does not belong to the path of the target map before the updating is used as a pixel point not belonging to the initial map path; and
updating the target map based on a result of a last iteration.

10. The method according to claim 1, wherein the generating a target map based on an intermediate map path obtained after a last iteration comprises:
randomly filling each map decoration element in each connected region within the preset geographic range according to a selection probability corresponding to the map decoration element, to obtain the target map comprising the map decoration element and the intermediate map path.

11. A map generation method, comprising:
obtaining a path sketch drawn by a user;
generating a target map based on the path sketch;
receiving modification information for the path sketch from the user; and
updating the target map based on a path portion which is indicated to be modified by the modification information.

12. The method according to claim 11, further comprising:
determining an associated geographic range comprising the path portion which is modified and selected by the user, wherein a portion of the target map outside the associated geographic range is not updated, and
wherein the updating the target map based on a path portion which is indicated to be modified by the modification information comprises: updating the target map based on the path portion which is indicated to be modified by the modification information and the associated geographic range.

13. The method according to claim 11, wherein the updating the target map based on a path portion which is indicated to be modified by the modification information comprises:
determining an updated path sketch based on the path portion which is indicated to be modified by the modification information, and generating an updated skeleton map based on the updated path sketch; and determining an associated geographic range corresponding to the path portion which is indicated to be modified;
updating a map path transition probability based on the updated path sketch, the updated skeleton map, and the associated geographic range, wherein setting a map path transition probability of each pixel point located in the path of the target map before the updating and outside the associated geographic range to be 1, and setting a map path transition probability of each pixel point not located in the path of the target map before the updating to be 0; and
generating an initial map path after updating based on the map path transition probability after updating, and generating a target map after updating based on the initial map path after updating.

14-15. (canceled)

16. A computer apparatus, comprising: at least one processor, a memory, and a bus, wherein the memory stores machine-readable instructions executable by the at least one processor, when the computer apparatus runs, the at least one processor and the memory communicate through the bus, and when the machine-readable instructions are executed by the at least one processor, a map generation method is executed, and the map generation method comprises:
obtaining a map path transition probability of each pixel point within a preset geographic range, wherein the map path transition probability is used to indicate a probability of the pixel point changing from a non-map path pixel point to a map path pixel point;
generating an initial map path based on the map path transition probability;
for each pixel point within the preset geographic range, determining whether the pixel point is a pixel point belonging to an intermediate map path, based on a proportion of pixel points belonging to the initial map path among neighborhood pixel points of the pixel point, to obtain the intermediate map path; and
using the intermediate map path as an initial map path after updating, repeatedly performing a step of determining the intermediate map path until a preset number of iterations is reached, and generating a target map based on an intermediate map path obtained after a last iteration.

17. A non-transitory computer-readable storage medium, wherein a computer program is stored on the computer-readable storage medium, and when the computer program is run by at least one processor, steps of the map generation method according to claim 1 are executed.

18. The method according to claim 13, wherein the updating the map path transition probability based on the updated path sketch, the updated skeleton map, and the associated geographic range comprises:
determining an updated map path transition probability corresponding to each target pixel point, based on a path width weight and a Manhattan distance from the target pixel point to the updated path sketch, wherein the target pixel point is a pixel point outside the updated path sketch and the updated skeleton map and within a preset geographic range which is located within the associated geographic range; and
setting a map path transition probability of the pixel point in the updated path sketch within the associated geographic range to be 1, and setting a map path transition probability of the pixel point in the updated skeleton map within the associated geographic range to be 0.

19. The method according to claim 13, wherein the generating a target map after updating based on the initial map path after updating comprises:
for each pixel point within the associated geographic range, determining whether the pixel point is a pixel point belonging to an intermediate map path, based on a proportion of pixel points belonging to the initial map path among neighborhood pixel points of the pixel point, to obtain the intermediate map path after updating;
using the intermediate map path after updating as the initial map path after updating, and repeatedly performing a step of determining the intermediate map path after updating until a preset number of iterations is reached, wherein in each iteration process, a neighborhood pixel point which is not located within the associated geographic range and belongs to the path of the target map before the updating is used as a pixel point belonging to the initial map path, and a neighborhood pixel point which is not located within the associated geographic range and does not belong to the path of the target map before the updating is used as a pixel point not belonging to the initial map path; and
updating the target map based on a result of a last iteration.

20. The computer apparatus according to claim 16, wherein the generating a target map based on an intermediate map path obtained after a last iteration comprises:
when a plurality of map path portions are not connected in the intermediate map path, starting a plurality of agent threads;
determining a current to-be-connected map path portion from the plurality of map path portions, and for each of the plurality of agent threads, randomly selecting one pixel point from the current to-be-connected map path portion as a start pixel point, and randomly generating one candidate path from the start pixel point to another map path portion; and using a shortest path in the candidate paths generated by the plurality of agent threads as a path of the target map; and
repeating a step of determining the current to-be-connected map path portion from the plurality of map path portions until connection for the plurality of map path portions are established, to obtain the path of the target map.

21. The computer apparatus according to claim 16, wherein before generating an initial map path based on the map path transition probability, the method further comprises:
obtaining a path sketch drawn by a user;
generating a skeleton map based on the path sketch, wherein a style of the skeleton map matches a style of the path sketch, and the skeleton map comprises no pixel point belonging to the path sketch; and
determining the map path transition probability based on the path sketch and the skeleton map.

22. The computer apparatus according to claim 21, wherein the determining the map path transition probability based on the path sketch and the skeleton map comprises:
determining a map path transition probability of each pixel point outside the path sketch and the skeleton map belonging to the initial map path, based on an obtained path width weight and a Manhattan distance from the pixel point outside the path sketch and the skeleton map and within the preset geographic range to the path sketch, setting a map path transition probability of the pixel point in the path sketch to be 1, and setting a map path transition probability of the pixel point in the skeleton map to be 0.
